(19) United States
(12) Patent Application Publication
(10) Pub. No.: US 2012/0317602 A1
(43) Pub. Date: Dec. 13, 2012

(54) Channel Navigation Techniques

(75) Inventors: Bradley R. Pettit, Los Gatos, CA (US); Eric R. Soldan, Saratoga, CA (US)

(73) Assignee: Microsoft Corporation, Redmond, WA (US)

(21) Appl. No.: 13/159,173

(22) Filed: Jun. 13, 2011

(51) Int. Cl. H04N 5/445

(52) U.S. Cl. 725/45; 725/44

(57) ABSTRACT

Channel navigation techniques are described. In one or more implementations, a channel up or channel down command is received during output of content available via a first television channel. Responsive to this, navigation is caused to a second television channel in a list to output content available via the second television channel, the list formed to include channels that have content that is currently available and that is similar to the content that is output via the first television channel.

### BACKGROUND

Initially, users had access to a handful of channels via which to view content. Therefore, users could readily determine “what was on” and choose content accordingly. As the number of channels continued to increase, techniques were then developed to aide users in locating content of interest. For example, these techniques may include use of paper program guides that were printed in newspapers to electronic program guides that were available with the television content itself. However, the numbers of channels have continued to increase such that it may be difficult for users to locate content of interest even with the aid of these conventional techniques.

### SUMMARY

Channel navigation techniques are described. In one or more implementations, a channel up or channel down command is received during output of content available via a first television channel. Responsive to this, navigation is caused to a second television channel in a list to output content available via the second television channel, the list formed to include channels that have content that is currently available and that is similar to the content that is output via the first television channel.

In one or more implementations, a list of channels is generated that includes content that is currently available from a broadcast via a respective channel and that is similar, one to another. Responsive to entry into a channel navigation mode that involves the list, the list is used to navigate through the channels that have similar content and to skip navigation through at least one of the channels having currently available content that is not similar.

In one or more implementations, an apparatus includes one or more television tuners and one or more modules implemented at least partially in hardware. The one or more modules are configured to output content received by the one or more television tuners via a first television channel, receive a channel up or channel down command during output of the content, identify a second television channel from a list formed to include channels that have content that is currently available via the one or more television tuners and that is similar to the content that is output via the first television channel, and tune the one or more television tuners to the second television channel.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques relating to channel navigation.

FIG. 2 depicts an example system showing a remote control device of FIG. 1 in greater detail as including a similar button operable to initiate a mode to navigate through similar content.

FIG. 3 is a flow diagram depicting a procedure in an example implementation in which a list is generated for use in navigating through currently displayed content that is similar.

FIG. 4 is a flow diagram depicting a procedure in an example implementation in which channel up or channel down commands are used to navigate through a list of channels having currently available content that is similar.

FIG. 5 illustrates various components of an example device that can be implemented as any type of computing device as described with reference to FIGS. 1 and 2 to implement embodiments of the techniques described herein.

### DETAILED DESCRIPTION

### Overview

The number of channels via which a user may receive television content is ever increasing. Accordingly, traditional techniques that were developed to aid in locating content may also be overwhelmed by the vast amount of choices that have been made available to users. For example, when a user would select channels via the channel up or down buttons, the user was typically restricted to a set of available channels, whether or not the channel had a program of interest. Restricting the set of available channels using traditional techniques was based on a channel number (e.g., favorite channels), even though a particular excluded channel may have a program of interest.

Channel navigation techniques are described. In one or more implementations, characteristics of content that is currently output by a computing device is leveraged to find similar content, which may include content that matches a currently viewed television program and/or content filtering criteria. A user, for instance, may view a basketball game that is part of a tournament. To find other basketball games in the tournament that might be available on other channels, a computing device may leverage the characteristics of a currently viewed television content (e.g., through identification of a genre) to locate other television content that is currently available via other channels. This may be used to determine a variety of other similar content, such as another sporting event (e.g., hockey), and thus similarity may be based on any criteria considered to be similar to criteria of a current program.

The computing device may then provide techniques to navigate between these channels, such as by entering a mode in which a channel up or channel down command is used to navigate through a list of the channels. Thus, metadata of the programs may be used to restrict a current channel set that is made available to a user. In this way, a user may efficiently navigate through similar content without navigating away from a content viewing session, and thus may be implemented to be non-modal. A variety of other examples are also contemplated, further discussion of which may be found in relation to the following sections.

In the following discussion, an example environment and systems are first described that is operable to perform techniques related to content navigation. Example procedures are then described that may be employed in the example environment, as well as in other environments. Although the techniques are described in a television environment in the following discussion, it should be readily apparent that a wide variety of goods and/or services may also leverage these techniques without departing from the spirit and scope thereof.

Example Environment

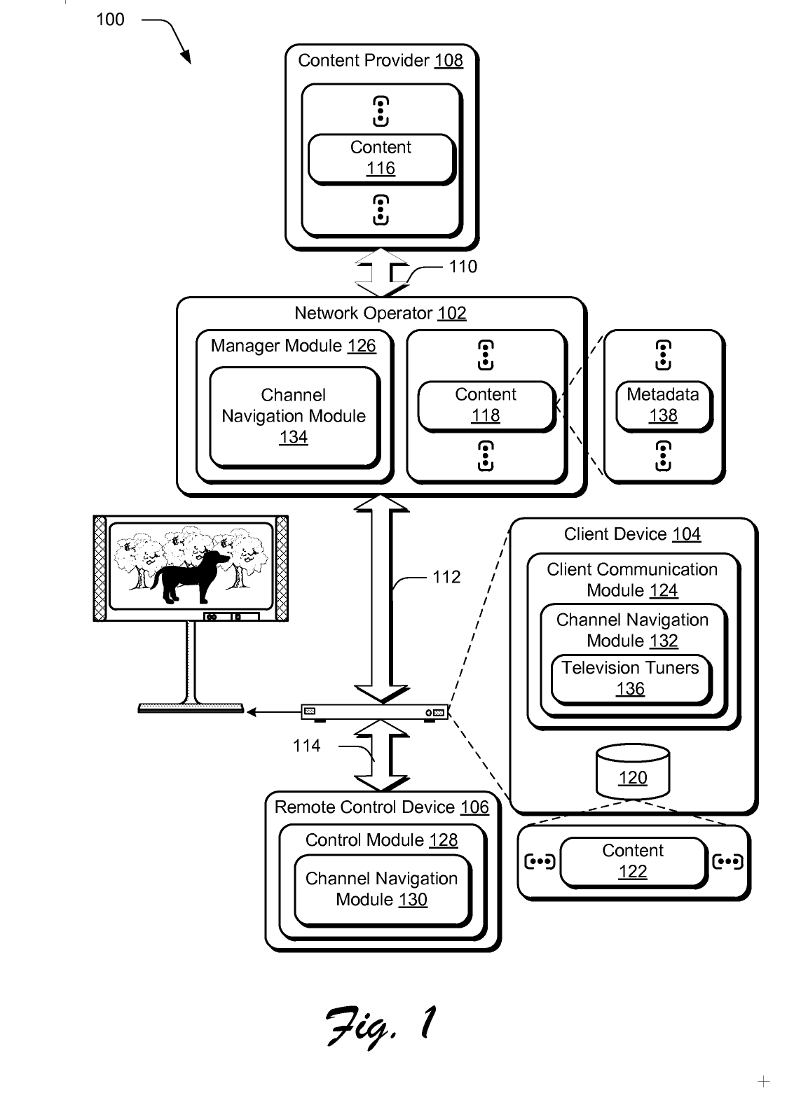

FIG. 1 is an illustration of an environment 100 in an example implementation that is operable to employ techniques to related to content navigation. The illustrated environment 100 includes a network operator 102 (e.g., a “head end”), a client device 104, a remote control device 106 and a content provider 108 that are communicatively coupled, one to another, via network connections 110, 112, 114. In the following discussion, the network operator 102, the client device 104, the remote control device 106 and the content provider 108 may be representative of one or more entities, and therefore by convention reference may be made to a single entity (e.g., the client device 104) or multiple entities (e.g., the client devices 104, the plurality of client devices 104, and so on).

Additionally, although a plurality of network connections 110-114 are shown separately, the network connections 110-114 may be representative of network connections achieved using a single network or multiple networks, e.g., network connections 110, 112 may be implemented via the internet and network connection 114 may be implemented via a local network connection, such as via infra red, a radio frequency connection, and so on. In another example, network connection 114 may also be implemented via the internet.

The client device 104 may be configured in a variety of ways. For example, the client device 104 may be configured as a computing device that is capable of communicating over the network connections 112, 114, such as a television, a mobile station, an entertainment appliance (e.g., a game console), a set-top box communicatively coupled to a display device as illustrated, a wireless phone, and so forth. Thus, the client device 104 may range from a full resource device with substantial memory and processor resources (e.g., television-enabled personal computers, television recorders equipped with hard disk) to a low-resource device with limited memory and/or processing resources (e.g., traditional set-top boxes).

Communication of content to the client device 104 may be performed in a variety of ways. For example, the client device 104 may be communicatively coupled to the content provider 108 (which may be representative of one or more content providers) using a packet-switched network, e.g., the Internet, to receive a broadcast of the content 118. Accordingly, the client device 104 may receive one or more items of content 116 directly from the content provider 108, e.g., via one or more websites, via a cable connection, a satellite connection, digital subscriber line (DSL), and so on. The content 116 may include a variety of data, such as television programming, video-on-demand (VOD) files, one or more results of remote application processing, and so on. A variety of other examples are also contemplated, such as by using an indirect distribution example in which the content 116 is communicated over the network connection 110 to the network operator 102.

Content 116, as illustrated in FIG. 1, is communicated via the network connection 110 is received by the network operator 102 and may be stored as one or more items of content 118. The content 118 may be the same as or different from the content 116 received from the content provider 108. The content 118, for instance, may include additional data for broadcast to the client device 104. For example, the content 118 may include electronic program guide (EPG) data from an EPG database for broadcast to the client device 104 utilizing a carousel file system and an out-of-band (OOB) channel. Distribution from the network operator 102 to the client device 104 over network connection 112 may be accommodated in a number of ways, including cable, radio frequency (RF), microwave, digital subscriber line (DSL), and satellite. Other implementations are also contemplated such as to obtain metadata from a third-party source.

The client device 104, as previously stated, may be configured in a variety of ways to receive the content 118 over the network connection 114. The client device 104 typically includes hardware and software to transport and decrypt content 118 received from the network operator 102 for output to and rendering by the illustrated display device. Although a display device is shown, a variety of other output devices are also contemplated, such as speakers. Further, although the display device is illustrated separately from the client device 104, it should be readily apparent that the client device 104 may also include the display device as an integral part thereof.

The client device 104 may also include digital video recorder (DVR) functionality. For instance, the client device 104 may include a storage device 120 to record content 118 as content 122 received via the network connection 112 for output to and rendering by the display device. The storage device 120 may be configured in a variety of ways, such as a hard disk drive, a removable computer-readable medium (e.g., a writable digital video disc), and so on. Thus, content 122 that is stored in the storage device 120 of the client device 104 may be copies of the content 118 that was streamed from the network operator 102. Additionally, content 122 may be obtained from a variety of other sources, such as from a computer-readable medium that is accessed by the client device 104, and so on. For example, content 122 may be stored on a digital video disc (DVD) when the client device 104 is configured to include DVD functionality.

The client device 104 includes a client communication module 124 that is representative of functionality of the client device 104 to control content interaction on the client device 104, such as through the use of one or more “control functions”. The control functions may include a variety of commands to control output of content, such as to control volume, change channels, select different inputs, configure surround sound, and so on. The control functions may also provide non-linear playback of the content 122 (i.e., time shift the playback of the content 122) such as pause, rewind, fast forward, slow motion playback, and the like. For example, during a pause, the client device 104 may continue to record the content 118 in the storage device 120 as content 122. The client device 104, through execution of the client communication module 124, may then playback the content 122 from the storage device 120, starting at the point in time the content 122 was paused, while continuing to record the currently-broadcast content 118 in the storage device 120 from the network operator 102.

The network operator 102 is illustrated as including a manager module 126. The manager module 126 is representative of functionality to configure content 118 for output (e.g., streaming) over the network connection 112 to the client device 104. The manager module 126, for instance, may configure content 116 received from the content provider 108 to be suitable for transmission over the network connection 112, such as to “packetize” the content for distribution over the Internet, configuration for a particular broadcast channel, and so on.

Thus, in the environment 100 of FIG. 1, the content provider 108 may broadcast the content 116 over a network connection 110 to a multiplicity of network operators, an example of which is illustrated as network operator 102. The network operator 102 may then stream the content 118 over a network connection 112 to a multitude of clients, an example of which is illustrated as client device 104. The client device 104 may then store the content 118 in the storage device 120 as content 122, such as when the client device 104 is configured to include digital video recorder (DVR) functionality, and/or output the content 118 directly.

The remote control device 106 is illustrated as including a control module 128 that is representative of functionality to control operation of the remote control device 106. The remote control device 106 may be configured in a variety of ways, such as a traditional remote control having physical buttons, a mobile device such as a tablet computer, and so on. The control module 128, for instance, is representative of functionality to initiate control functions of the client device 104. For example, the control module 128 may be configured to receive inputs related to selection of representations of control functions, such as a selection of a “channel up” or “channel down” representation on the remote control device 106 using a button, a display of a button, and so forth. Data representing selection of this command may then be communicated via network connection 114 to the client device 104 that causes the client device 104 (e.g., the client communication module 124) to change a channel. A variety of other control functions may also be initiated by the control function module 128 as previously described.

Channel navigation modules 130, 132, 134 are further illustrated as being included by the remote control device 106, the client device 104, and the network operator 102, respectively. The channel navigation modules 130, 132, 134 are representative of functionality to perform channel navigation, such as to cause the client device 104 to tune one or more television tuners 136, the network operator 102 to stream particular content 118, and so on.

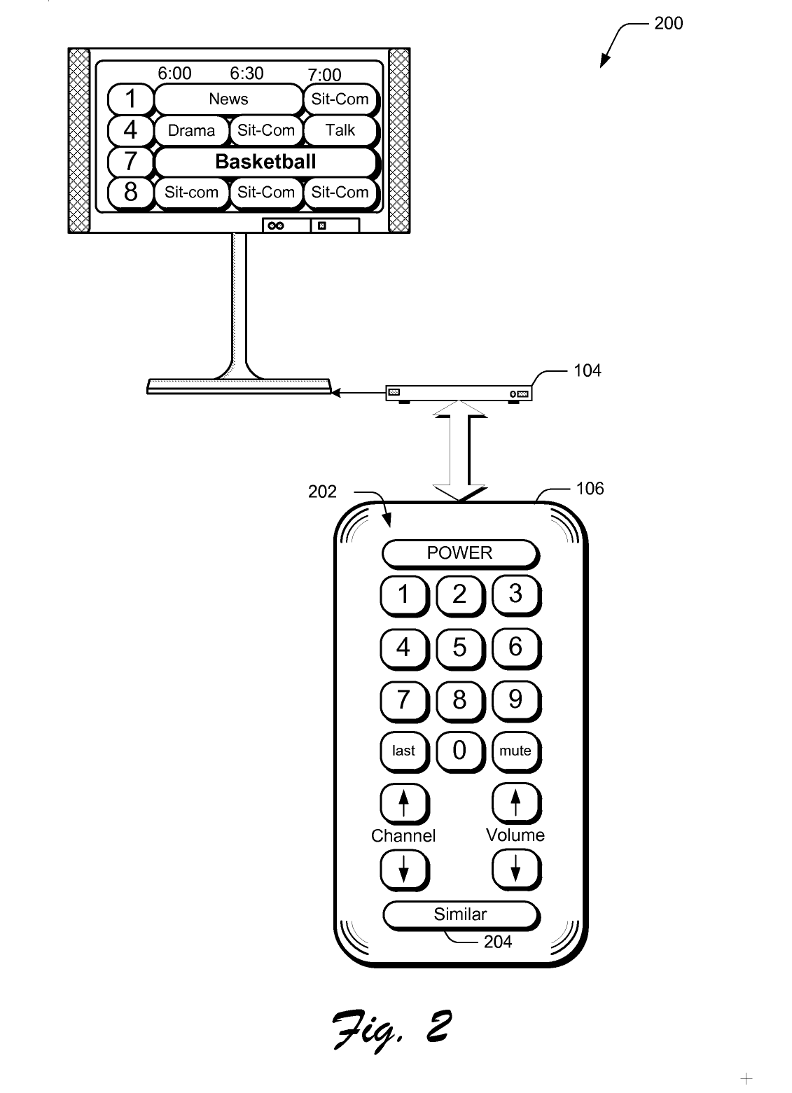

For example, one or more of the channel navigation modules 130, 132, 134 may implement techniques to provide criteria-restricted channel navigation, e.g., channel surfing. These techniques, for instance, may be used to generate a list of channels that have similar content that is currently available via the respective channels. This similarity may be determined in a variety of ways, such as through examination of metadata 138, electronic program guide data, and so on that describes criteria such as genre, actor, director, rating, and so forth. Thus, in one or more implementations the list may be based on the characteristics of the currently available content itself and not based on characteristics of the channel. The list may be used in a variety of different ways, an example of which is described in relation to FIG. 2.

FIG. 2 depicts an example system 200 showing the remote control device 106 in greater detail as displaying representations 202 of one or more control functions of the client device 104 that may be initiated through selection on the remote control device 106. As previously described, the remote control device 106 may assume a variety of configurations, such as a mobile device (e.g., tablet computer or wireless phone), dedicated remote control device having physical buttons, and so on. The illustrated example of the remote control device 106 includes a display device (e.g., a touch screen) that consumes approximately half of an outer surface of the remote control device thereby giving the remote control device an appearance of a “glassy brick” although other configurations are also contemplated such as a tablet.

In another implementation, the display device of the remote control device 104 covers at least forty percent of the outer surface of the remote control device 104. In a further implementation, the display device consumes, approximately, an outer surface of the remote control device 106 that is viewable by a user when placed on a surface (e.g., a top of a table) and/or grasped in a hand of the user, e.g., the illustrated outer surface of the remote control device 106 in FIG. 2. A variety of other implementations are also contemplated, such as implementations in which the display device of the remote control device 106 includes more or less than the previously described amounts of the outer surface of the remote control device 106.

The display device may be implemented such that representations of commands (e.g., control functions) and other data are selectable on the remote control device 106. For example, different portions of the display device of the remote control device 106 may be configured to detect contact and/or proximity of an object to the display device such that different portions of the display device are selectable. A variety of different techniques may be used to detect selection, such as through resistive techniques, surface acoustic waves, capacitive, infrared, use of strain gauges, optical imaging, dispersive signal technology, acoustic pulse recognition, frustrated total internal reflection, and so on. Using these techniques, a variety of different representations of may be displayed for selection by a user.

By selecting one or more of the representations 202, a user may supply an input to initiate the represented control function by the client device 104. As illustrated by the remote control device 106 of FIG. 2, for instance, a user may select a “power” representation, one or more numbers to select a channel, “mute”, “last”, “channel up”, “channel down”, “volume up,” and “volume down.” Thus, the remote control device 106 may communicate with the client device 104 to control output of content by the client device 104.

The remote control device 106 is also illustrated as having a “similar” button 204. Selection of the similar button 204 may be used to initiate techniques to perform channel navigation through similar content. A variety of other techniques may also be used to initiate the techniques, such as selection of an option in a graphical user interface, recognition of a gesture, and so forth.

The list may be utilized in a variety of different ways to support criteria restricted channel navigation. For example, pressing the similar button 204 may cause the client device 104 to enter a criteria-restricted mode. In this mode, navigation may be performed through content items that are similar to what is currently output by the client device 104, e.g., to content currently displayed when the similar button 204 is selected. This navigation, for instance, may be performed using the channel up or channel down buttons displayed on the remote control device 106 to navigate through the list. In another instance, repeated pressing of the similar button 204 may cause the client device 104 to output a next channel on the list by “channeling up” or “channeling down” through the list.

The list may also be used to output selections in a user interface that are selectable by a user. For example, selection of the similar button 204 may cause output of a user interface having an electronic program guide. This electronic program guide may be configured to include channels having similar content to the content that is currently displayed and to skip display of channels having content that is not similar. The electronic program guide, for instance, may be filtered based on selection of the similar button 204 to include content that is similar to an item currently selected, such as “basketball” as illustrated. In another example, selection of the similar button 204 may cause output of a list of genres or other criteria that may be used to base similarity of content. Selection of the criteria may then cause a list to be utilized having similarity of content based on the selected criteria.

Further, the list may be updated in a variety of ways. For example, the list may be formed to include content that is similar to currently displayed content. Navigation may then be performed through the list without updating the list. In another example, the list may be formed each time the similar button 204 is pressed such that the list is dynamically updated as a user navigates through the list.

In a further example, the list may be dynamically updated responsive to a change in content availability, such as at predetermined intervals of time at which programming is approximately changed by one or more of the channels, through monitoring of data (e.g., monitoring electronic program guide data), and so forth. Therefore, content that is included in a list at 6:59 may be quite different than content that is included in the list at 7:00. Thus, the techniques may be performed efficiently in one or more implementations since the EPG data for the current time may be local to the client device 104 and/or remote control device 106 thereby reducing an amount of network traffic. A variety of other examples are also contemplated, further discussion of which may be found in relation to the following procedures.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors.

For example, the computing device may also include an entity (e.g., software) that causes hardware of the computing device to perform operations, e.g., processors, functional blocks, and so on. For example, the computing device may include a computer-readable medium that may be configured to maintain instructions that cause the computing device, and more particularly hardware of the computing device to perform operations. Thus, the instructions function to configure the hardware to perform the operations and in this way result in transformation of the hardware to perform functions. The instructions may be provided by the computer-readable medium to the computing device through a variety of different configurations.

One such configuration of a computer-readable medium is signal bearing medium and thus is configured to transmit the instructions (e.g., as a carrier wave) to the hardware of the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

Example Procedures

The following discussion describes techniques that may be implemented utilizing the previously described environment, systems, user interfaces and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and system 200 of FIG. 2, respectively.

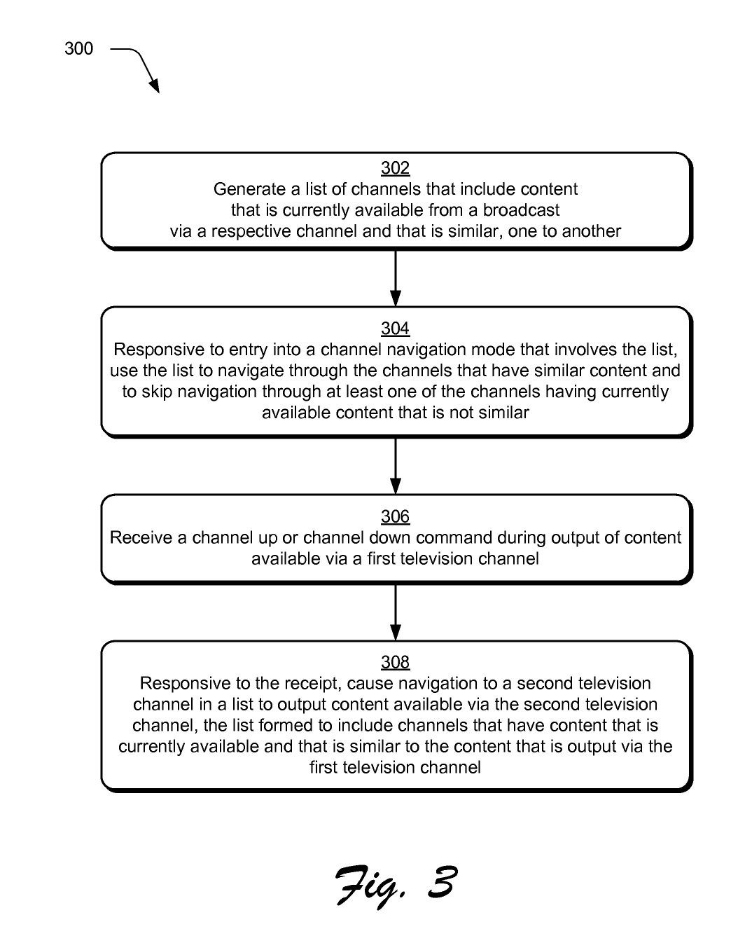

FIG. 3 depicts a procedure 300 in an example implementation in which a list is generated for use in navigating through currently displayed content that is similar. A list of channels is generated that includes content that is currently available from a broadcast via a respective channel and that is similar, one to another (block 302). As previously described, the list may be generated in a variety of ways, such as responsive to receipt of an input, responsive to a change in content availability, and so on. Further, criteria that are used as a basis of the similarity may take a variety of forms, such as genre, actors, director, rating, and so forth.

Responsive to entry into a channel navigation mode that involves the list, the list is used to navigate through the channels that have similar content and to skip navigation through at least one of the channels having currently available content that is not similar (block 304). The mode may be entered in a variety of ways, such as by pressing a similar button 204 as described in relation to FIG. 2, selection through a menu, and so forth. Additionally, the list may be used in a variety of different ways to perform the navigation.

For example, a channel up or channel down command may be received during output of content available via a first television channel (block 306). The command, for instance, may involve pressing a channel up or channel down button, selection in a menu, successive pressing of the similar button 204 to initiate the command, and so forth.

Responsive to this, navigation is caused to a second television channel in a list to output content available via the second television channel, the list formed to include channels that have content that is currently available and that is similar to the content that is output via the first television channel (block 308). The navigation, for instance, may cause a display of content in the first channel to be replaced with a display of content from the second channel, may involve movement through menus such as navigation through a picture-in-picture display, and so on. For instance, a user may press an “up” button. Responsive to this, a menu may be output having a list of programs that are selectable by a user.

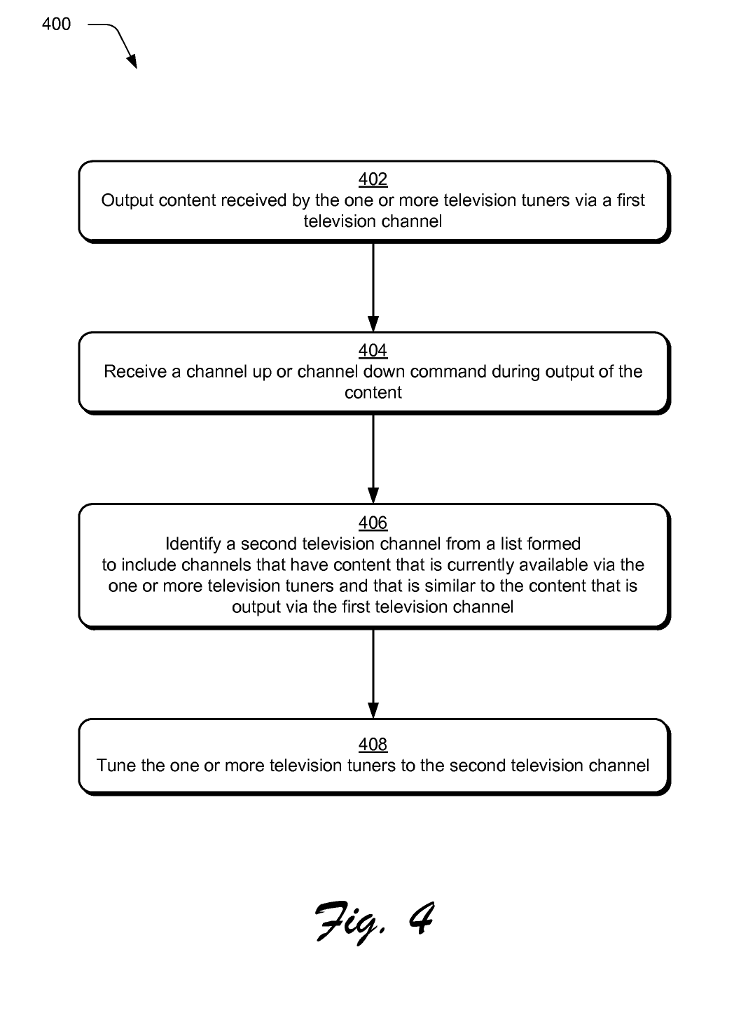

FIG. 4 is a flow diagram depicting a procedure 400 in an example implementation in which channel up or channel down commands are used to navigate through a list of channels having currently available content that is similar. Content is output that was received by the one or more television tuners via a first television channel (block 402). The client device 104, for instance, may receive a broadcast of content 118 via a network connection 112 by using one or more television tuners 136. The client device 104 may then cause the content to be output for display by a display device.

A channel up or channel down command is received during output of the content (block 404). As previously described, the channel up or channel down commands may be received in a variety of ways. For example, the client device 104 may receive a command from the remote control device 106. A channel navigation module 130 may receive the command itself responsive to selection of a button. Likewise, a network operator 102 may receive a command from the remote control device 106 directly and/or indirectly through the client device 104. A variety of other examples are also contemplated.

A second television channel is identified from a list formed to include channels that have content that is currently available via the one or more television tuners and that is similar to the content that is output via the first television channel (block 406). A channel navigation module 132, for instance, may examine a list to determine which channel also has content that is currently available and that is similar to the content received via the first channel. The one or more television tuners are then tuned to the second television channel (block 408) such that content form the second television channel may be output for display by a display device. A variety of other examples are also contemplated, such as navigation through electronic program guides and so on as previously described.

Example Device

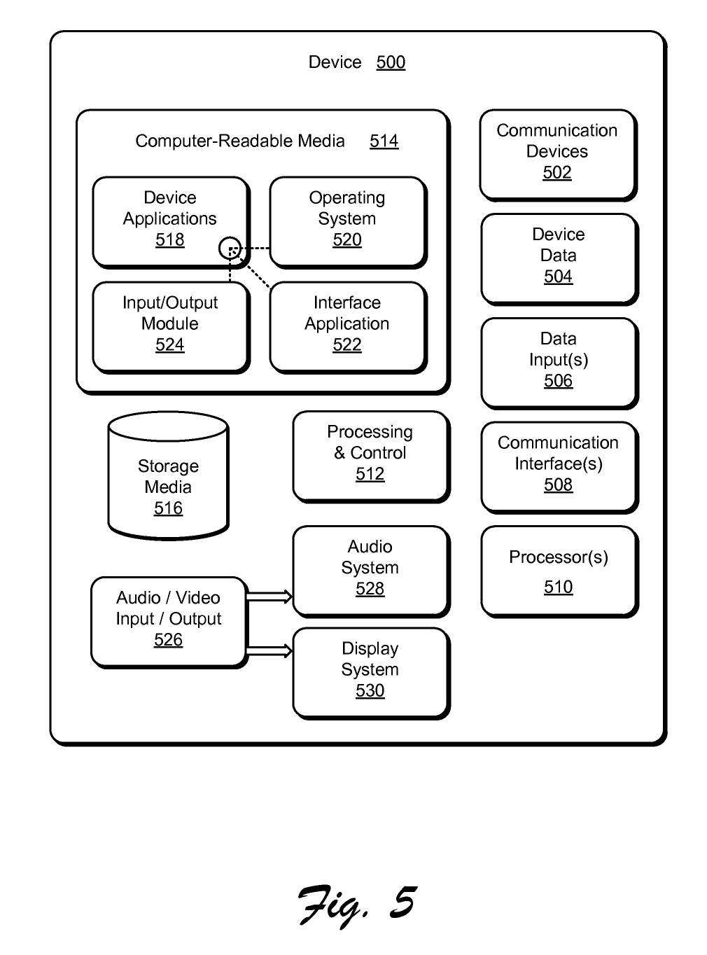

FIG. 5 illustrates various components of an example device 500 that can be implemented as any type of computing device as described with reference to FIGS. 1 and 2, to implement embodiments of the techniques described herein. Device 500 includes communication devices 502 that enable wired and/or wireless communication of device data 504 (e.g., received data, data that is being received, data scheduled for broadcast, data packets of the data, etc.). The device data 504 or other device content can include configuration settings of the device, media content stored on the device, and/or information associated with a user of the device. Media content stored on device 500 can include any type of audio, video, and/or image data. Device 500 includes one or more data inputs 506 via which any type of data, media content, and/or inputs can be received, such as user-selectable inputs, messages, music, television media content, recorded video content, and any other type of audio, video, and/or image data received from any content and/or data source.

Device 500 also includes communication interfaces 508 that can be implemented as any one or more of a serial and/or parallel interface, a wireless interface, any type of network interface, a modem, and as any other type of communication interface. The communication interfaces 508 provide a connection and/or communication links between device 500 and a communication network by which other electronic, computing, and communication devices communicate data with device 500.

Device 500 includes one or more processors 510 (e.g., any of microprocessors, controllers, and the like) which process various computer-executable instructions to control the operation of device 500 and to implement embodiments of the techniques described herein. Alternatively or in addition, device 500 can be implemented with any one or combination of hardware, firmware, or fixed logic circuitry that is implemented in connection with processing and control circuits which are generally identified at 512. Although not shown, device 500 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 500 also includes computer-readable media 514, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 500 can also include a mass storage media device 516.

Computer-readable media 514 provides data storage mechanisms to store the device data 504, as well as various device applications 518 and any other types of information and/or data related to operational aspects of device 500. For example, an operating system 520 can be maintained as a computer application with the computer-readable media 514 and executed on processors 510. The device applications 518 can include a device manager (e.g., a control application, software application, signal processing and control module, code that is native to a particular device, a hardware abstraction layer for a particular device, etc.). The device applications 518 also include any system components or modules to implement embodiments of the gesture techniques described herein. In this example, the device applications 518 include an interface application 522 and an input/output module 524 (which may be the same or different as input/output module 114) that are shown as software modules and/or computer applications. The input/output module 524 is representative of software that is used to provide an interface with a device configured to capture inputs, such as a touchscreen, track pad, camera, microphone, and so on. Alternatively or in addition, the interface application 522 and the input/output module 524 can be implemented as hardware, software, firmware, or any combination thereof. Additionally, the input/output module 524 may be configured to support multiple input devices, such as separate devices to capture visual and audio inputs, respectively.

Device 500 also includes an audio and/or video input-output system 526 that provides audio data to an audio system 528 and/or provides video data to a display system 530. The audio system 528 and/or the display system 530 can include any devices that process, display, and/or otherwise render audio, video, and image data. Video signals and audio signals can be communicated from device 500 to an audio device and/or to a display device via an RF (radio frequency) link, S-video link, composite video link, component video link, DVI (digital video interface), analog audio connection, or other similar communication link. In an embodiment, the audio system 528 and/or the display system 530 are implemented as external components to device 500. Alternatively, the audio system 528 and/or the display system 530 are implemented as integrated components of example device 500.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by a computing device, the method comprising:
receiving a channel up or channel down command during output of content available via a first television channel; and
responsive to the receiving, causing navigation to a second television channel in a list to output content available via the second television channel, the list formed to include channels that have content that is currently available and that is similar to the content that is output via the first television channel.

2. A method as described in claim 1, wherein at least one channel is excluded from the list because content of the at least one channel is not similar to the content that is output via the first television channel.

3. A method as described in claim 1, wherein the similarity is based on genre.

4. A method as described in claim 1, wherein the navigating is performed responsive to entry of mode to cause navigation through currently available content that is similar and to skip navigation through currently available content that is not similar.

5. A method as described in claim 4, wherein the mode is configured to specify a particular genre to define the similarity.

6. A method as described in claim 4, wherein entry into the mode is initiated through selection of a dedicated button output in a user interface of a remote control device.

7. A method as described in claim 1, wherein the computing device is a client device that is configured to receive the command from a remote control device and output the content from the channels that is received via a broadcast.

8. A method as described in claim 1, wherein the navigating includes content that is stored locally at the computing device.

9. A method as described in claim 1, further comprising dynamically updating the list responsive to a change in availability of content via a broadcast.

10. A method implemented by one or more computing devices, the method comprising:
generating a list of channels that include content that is currently available from a broadcast via a respective said channel and that is similar, one to another; and
responsive to entry into a channel navigation mode that involves the list, using the list to navigate through the channels that have similar said content and to skip navigation through at least one of the channels having currently available content that is not similar.

11. A method as described in claim 10, wherein the generating is performed responsive to receipt of a channel up or channel down command.

12. A method as described in claim 10, wherein the generating is performed responsive to selection of a dedicated button output in a user interface of a remote control device.

13. A method as described in claim 10, wherein the using includes creation of an electronic program guide that includes one or more of the channels that have similar said content and does not include the channels that having currently available content that is not similar.

14. A method as described in claim 10, wherein the similarity is based at least in part on genre.

15. An apparatus comprising:
one or more television tuners; and
one or more modules implemented at least partially in hardware, the one or more modules configured to:
output content received by the one or more television tuners via a first television channel;
receive a channel up or channel down command during output of the content;
identify a second television channel from a list formed to include channels that have content that is currently available via the one or more television tuners and that is similar to the content that is output via the first television channel; and
tune the one or more television tuners to the second television channel.

16. An apparatus as described in claim 15, wherein the similarity is based at least in part on genre.

17. An apparatus as described in claim 15, wherein the one or more modules are configured to output a user interface having one or more criteria that are selectable to specify a basis for the similarity.

18. An apparatus as described in claim 15, wherein the one or more modules are further configured to dynamically update the list responsive to a change in availability of content via a broadcast.

19. An apparatus as described in claim 15, wherein the one or more modules are further configured to dynamically update the list at predefined intervals of time.

20. An apparatus as described in claim 15, wherein the list is formed responsive to the receipt of the command.
